(19) United States
(12) Patent Application Publication
(10) Pub. No.: US 2026/0220649 A1
(43) Pub. Date: Jul. 30, 2026

(54) EXTRACTION OF COMMUNICATION INSIGHTS FROM OPTIMAL ARTIFICIAL INTELLIGENCE MODEL SELECTION DURING COMPUTING SERVICE ISSUE HANDLING

(71) Applicant: PAYPAL, INC., San Jose, CA (US)

(72) Inventors: Shupeng Geng, Shanghai (CN); Ming Yuan, Shanghai (CN)

(21) Appl. No.: 19/038,572

(22) Filed: Jan. 27, 2025

(51) Int. Cl. G06Q 30/016

(52) U.S. Cl. CPC G06Q 30/016

(57) ABSTRACT

There are provided systems and methods for extraction of communication insights from optimal AI model selection during computing service issue handling. An online transaction processor or other service provider may provide computing services and platforms to entities, which may include live agent and self-service assistance features.

To provide more comprehensive and accurate customer service and assistance to users, a service provider may provide optimized AI model selection for handling of customer service requests. The AI models may correspond to AI agents that perform extraction of communication insights and determination of recommendations for responding to the requests. When selecting the AI models, a pipeline of deep learning and large language models may be used to classify requests and generate support tickets. The support tickets may then be assigned to AI agents using a load optimization mechanism, which may consider current load by each AI agent and model performance.

### TECHNICAL FIELD

The present disclosure relates generally to generative artificial intelligence (AI) and models, and more specifically to optimal selection of large language models (LLMs) and other AI agents for computing service assistance and issue handling.

### BACKGROUND

Online service providers may offer various services to end users, merchants, and other entities. These may include providing computing services through different software applications, websites, platforms, and resources, such as those that may be involved with digital transaction processing. Further, the service provider may provide and/or facilitate the use of applications and websites for online payments, peer-to-peer (P2P) transfers, and/or other computing services to different entities including merchants or other entities and their corresponding users (e.g., code developers, employees, agents, etc.). However, use of these computing services may require implementation by new and foreign systems, which may require specific assistance. Users may encounter difficulties in finding the required resources and instructions, and personalized assistance or human agents is costly and may not be widely available to assist these entities.

Frontline support may provide such assistance, such as customer service agents; however, such support may require a significant amount of time for reviewing and handling communications from multiple different communication channels including customers'phone calls, messaging text, email, social media, etc. It may also be difficult for these agents to extract actionable insights into issues with computing services and optimal issue handling for customer service requests from these communications in an efficient and effective manner. While handling numerous cases, it is time-consuming and challenging for human agents to handle analytical tasks manually. As the volume of cases increases, the existing array of tools available to human agents may lack cohesive integration, hindering the optimal selection of an agent, service system, and/or artificial intelligence (AI) model for customer service handling, response, and/or assistance. Thus, it is desirable to automate selection of AI models and agents for optimized efficiency and accuracy of assistance and response systems.

### BRIEF DESCRIPTION OF THE DRAWINGS

FIG. 1 is a block diagram of a networked system suitable for implementing the processes described herein, according to an embodiment;

FIGS. 2A and 2B are exemplary system environments for processing communications for service requests from users to optimally select an AI agent for insight extraction and recommendation, according to embodiments;

FIG. 3 is an exemplary diagram of processes for data collection and summarization for routing of service requests and other cases to optimal AI agents for insight extraction and recommendation, according to various embodiments;

FIG. 4 is an exemplary user interface displaying a support ticket for handling by an AI agent selected using an AI pipeline for optimized AI agent selection, according to various embodiments;

FIG. 5 is a flowchart of an exemplary process for communication insights from optimal AI model selection during computing service issue handling, according to an embodiment; and

FIG. 6 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for providing and processing communication insights from optimal AI model selection during computing service issue handling. Systems suitable for practicing methods of the present disclosure are also provided.

A service provider, such as an online transaction processor, may provide computing services to users and/or their corresponding entities, which may include individual customers or other individuals, merchant customers of an online transaction processor, businesses and their representatives and/or employees, and the like. These computing services may include those associated with electronic transaction processing, P2P payments and transfers, cryptocurrency trading, and other computing services involved with payment processing. For these computing services, merchants may require assistance and information when utilizing the available services and/or incorporating the services with their computing platforms, while individual users may encounter issues that require help and guidance. This may require performance of specific tasks and operations, and therefore many service providers provide different assistance and customer service systems and communication channels.

Conventionally, this type of assistance and instruction is provided through live agents and automated chatbots or self-service options, such as those that may provide responsive assistance to user outreach; however, these resources are limited in scope and/or availability. For AI agents that may provide automated and/or self-service assistance, optimal selection remains an issue and users may receive inefficient or inaccurate information, responses, and/or assistance if an improper AI agent is selected and/or used. This problem is further compounded when it comes to managing these insights based on business definitions and delivering them to the relevant product teams for known and unknown issues. Additionally, there is a need to continuously update data sources, such as an analysis leads repository, based on product changes to understand customer feedback. Further, customer service requires an automatic and quick pipeline/framework that may process customer utterances and product issues as input and generate comprehensive issue insights readouts to the product teams for handling, which conventional solutions do not provide. As such, current search systems lead to delays in response times and reduced efficiency in resolving support issues for users. Such users, including merchants, customers, and other entities or end users, may need help during onboarding or during subsequent interactions with the service provider, such as requesting information or help with a transaction or other services provided by the service provider.

In this regard, in various embodiments, a service provider may provide an autonomous customer service and assistance channels to address these challenges through automated and optimized AI agent selection based on communication insights extracted from user requests and conversations. A service provider may provide a comprehensive, multi-agent generative AI (Generative AI) powered system designed for extracting insights and providing feedback loop recommendations. This system may be composed of multiple agents, each of which may correspond to an LLM or other generative AI model, such as one based on a Bidirectional Encoder Representations from Transformers (BERT), specifically tailored for a unique task for assisting users and/or responding to user inquiries, assistance requests, service requests, or the like. The system may operate by gathering data from a variety of sources for different communications and/or customer service communications, requests, inquiries, messages, or the like from users. Each agent may utilize a corresponding generative AI model to extract insights from this data. The generative AI models may be specifically selected for handling based on load and other load balancing considerations, as well as overall system performance and efficiency. For example, a workload of each LLM, BERT-based model, and the like may be monitored so that new tasks may be assigned to an LLM with the least current load. This allows for load balancing between different LLM or other AI agents.

When providing more selective, efficient, and optimized load balancing, the load balancing mechanism may also analyze the number of tasks and the complexity of the tasks, which may be indicative of system resource usage and therefore true load of the AI agent. The mechanism may consider each model's performance, such as accuracy and the Net Promoter Score (NPS) of the final output. Further, reinforcement learning (RL) may be utilized by a component where a policy gradient method may provide additional load balancing optimization for complex customer service systems. A RL component of the load balancing mechanism may start with a random policy for task assignment or handling, and after each interaction with the environment (i.e., after each task assignment), the agent may receive a reward or penalty based on the outcome. The reward function considers factors such as the actual cost of resources for the result, the runtime/latency for obtaining an output, and the accuracy of the output and task completion. The RL component may then update one or more policies to maximize the expected cumulative reward by adjusting the weights of the reward function based on the feedback received from the environment of AI agent execution and output.

As such, AI agents may generate outputs and responses to user requests and queries more efficiently, with better load balancing and system resource utilization and distribution, and faster results. These outputs may correspond to insights extracted from the user's communications with the customer service and/or assistance interactions.

Insights for response to the user requests and queries may be transformed into issue reports with actionable recommendations, which may then be delivered to the relevant product teams for handling. Furthermore, the system may adapt and evolve to new incoming policy or product changes to services provided to users, which may allow for better selection of AI agents for insight extraction, for example, using the RL component. The system may add new analysis leads and AI agent availability to a repository of available AI agents in response to policy and product changes, ensuring that the insights and recommendations remain relevant and valuable. As such, the multi-agent system may enhance the stability and reliability of AI agents and customer service assistance through optimized agent selection, as well as significantly reduce the time required to identify and resolve issues. Further, through better selection of AI agents for communication insight extraction, the automated customer service system may provide rapid, effective solutions to customer service agents, thereby improving overall customer satisfaction. By emphasizing the multi-agent aspect, the system may provide versatility, adaptability, and efficiency in handling a wide range of tasks and challenges. As such, with increased accuracy and relevancy through optimized AI agent selection, the service provider may provide improved automated systems for customer request or assistance.

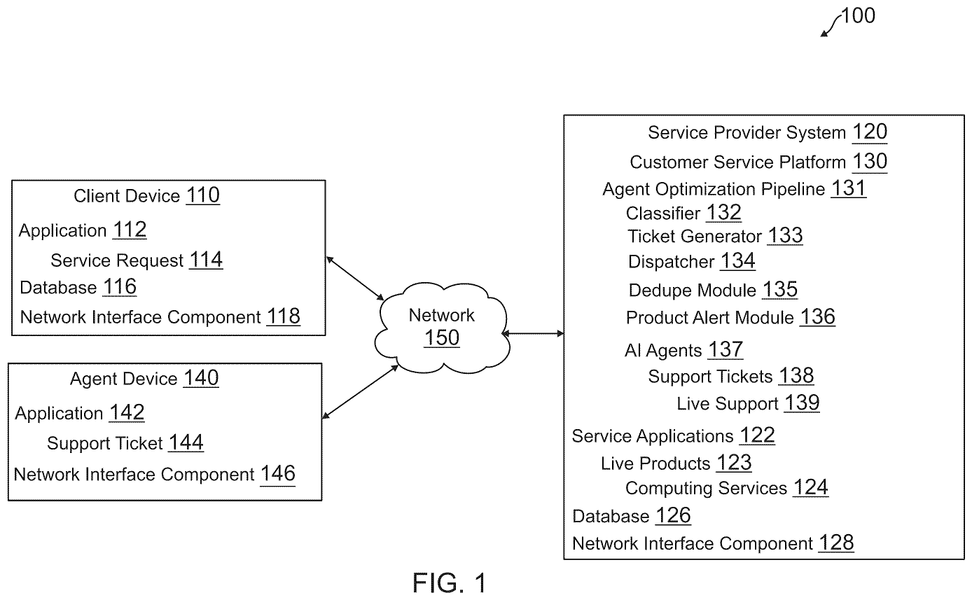

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110, a service provider system 120, and an agent device 140 in communication over a network 150. Client device 110 may be utilized by a customer or other user, including users associated with merchants or other entities, to send and receive communications over network 150 including those associated with assistance requests and customer service queries, questions, or requests. Service provider system 120 may provide various data, operations, and other functions over network 150 to provide services to merchants, users, and their computing systems and devices. In this regard, client device 110 may be used to request customer service assistance through one or more communication channels for customer service and assistance, where service provider system 120 may provide assistance and customer service using one or more LLMs or other generative AIs, as discussed herein. This may include optimization of selection of AI agents for assistance based on load balancing and the request. Once selected, an AI agent may extract insights and other information for provision to agent device 140, which may be used by an internal agent or other internal user, such as an assistance agent or employee of an entity associated with service provider system 120, to provide assistance and response to the user's request.

Client device 110, service provider system 120, and agent device 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device of a customer or other user that may interact with service provider system 120 for customer service and/or assistance, such as assistance with a product, service, or the like that may be provided by service provider system 120. Client device 110 may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user for use with service provider system 120, such as to provide access to and service of computing services provided by service provider system 120 for assistance and/or customer service. Application 112 may correspond to specialized software utilized by a user of client device 110 to generate and transmit a service request 114 requesting an answer, assistance, or other response from service provider system 120 using a customer service platform 130, which may utilize generative AIs for answer and/or response generation with live or real agents, chatbots, and the like. In some embodiments, service request 114 may include a query, a request, a statement, or the like that is provided to receive an answer, assistance, or response based on insights and information extracted from service request 114 and corresponding information, products, and/or knowledge available to service provider system 120 and corresponding agents. This may include a request or query for a search, a request for assistance, instructional lookup, a request for specific information or content, or the like. Service request 114 may also specify or otherwise identify a particular product, service, technology, or the like for which the user requires or is interested in obtaining assistance, instructions, usage, and the like. Application 112 may also be utilized to review and address responses to service request 114.

Application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. However, in other examples, application 112 may include a dedicated application of service provider system 120 or other entity that may interact with service provider system 120 during customer service and/or assistance requests. Thus, application 112 may also correspond to different service applications that may provide automated assistance include chatbots and other assistance automations. When utilizing application 112 with service provider system 120, application 112 may transmit service request 114 and receive responses to such prompt, question, or query, where service request 114 may be transmitted to provide assistance, instructions, or other help and information.

Client device 110 includes other applications as may be desired to provide features to client device 110. For example, these other applications may include security applications for implementing client-side security features, programmatic client applications for interfacing with appropriate application programming interfaces (APIs) over network 150, or other types of applications. Other applications on client device 110 may also include email, texting, voice and IM applications that allow a user to send and receive emails, calls, texts, and other notifications through network 150. In various embodiments, the other applications may include those that may be utilized in the course of compliance investigations, system administration, maintenance, debugging, error resolution, engineering, and the like. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 150, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120, agent device 140, and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide computing services and operations via one or more digital platforms, applications, websites, and the like. Service provider system 120 may provide computing services to various entities, which may include computing services provider to internal and/or external users including those associated with customer service and user assistance with help requests. For example, with the provision of computing products and/or services, assistance may be requested by customers and other users, which may be provided by live agents and/or an automated system utilizing customer service platform 130 for optimized AI agent selection and insight extraction. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes and/or is associated with service applications 122, a database 126, a network interface component 128, and a customer service platform 130, implementations of which are discussed further below. Service applications 122 and customer service platform 130 may correspond to executable processes, platforms, applications, and/or associated content and data with corresponding hardware. In other embodiments, service provider system 120 may include additional or different applications, platforms, and modules having corresponding hardware and/or software as required by their corresponding embodiments.

Customer service platform 130 may correspond to one or more processes to execute modules and associated specialized hardware of service provider system 120 to provide an agent optimization pipeline 131 that may be utilized to provide customer services via AI agents and internal agents to external customers associated with service provider system 120. In some embodiments, customer service platform 130 may correspond to specialized hardware and/or software used with an internal agent, employee, chatbot, or other user and/or automation to provide assistance to an agent associated with agent device 140 when aiding or assisting a user associated with client device 110, such as to provide the users with customer service or other assistance. As such, in some embodiments, an external user, such as a customer, may access customer service platform 130 to request customer service or assistance, or an agent associated with agent device 140 may utilize customer service platform 130 when assisting users with customer service and assistance requests.

For example, customer service platform 130 may receive service request 114 from client device 110 and process service request 114 using a classifier 132, a ticket generator 133, and a dispatcher 134 of agent optimization pipeline 131 to perform optimized selection of AI agents 137 for handling of support tickets 138. Further a dedupe module 135 and a product alert module 136 may be used to provide additional assistance and operations with handling of service requests and support tickets 138. As such, agent optimization pipeline 131 may correspond to a pipeline and/or framework of AI models and systems, such as LLMs and/or BERT-based models, to perform optimized agent selection of AI agents 137 for insight extraction of insights from the communications and conversations of service request 114. On receipt of input for service request 114, customer service platform 130 may utilize classifier 132 to classify the type and/or content of the conversation, communications, or other content from service request 114. Classifier 132 may utilize an LLM or other deep learning and/or language model to perform classification of communications or other content according to their type, information, subject, or the like.

Using the classified communications of service request 114, ticket generator 133 may perform support ticket generation using an LLM or other generative AI that may have language capabilities to process communications and generate support tickets in a particular format and/or content for support ticket processing and handling. Ticket generator 133 may correspond to an LLM that may summarize the issue, as well as account information or user information for the user submitting service request 114 for processing and response and may provide the summarization in support ticket format. As such, ticket generator 133 may generate support tickets 138 from incoming service requests, which may include support ticket 144 generated from service request 114.

After generation of a support ticket, such as support ticket 144 for assistance and handling of service request 114, dispatcher 134 may be utilized to predict a best or most optimized one of AI agents 137 for handling of support ticket 144 for service request 114. Dispatcher 134 may include one or more processes, modules, and/or AI models, such as a BERT-based model or the like, to perform selection of AI agents 137 for optimization of support request and ticket handling. In this regard, dispatcher 134 may include a load balancing mechanism that may utilize RL processes and modules. The load balancing mechanism may distribute service requests and support tickets evenly or in an optimized manner over those of AI agents 137 that are available and suited to handle the service request or ticket. This may be done by monitoring a workload of each LLM or other AI model of AI agents 137, as well as identifying the computational resources required to complete the tasks currently assigned to the agents. The mechanism may also utilize model performance, such as accuracy and/or NPS in the final output. With RL, a policy gradient method may be applied by dispatcher 134 where, when AI agent selection is performed, a policy for agent selection and/or load balancing may be selected (e.g., a policy for how agents should be assigned, what load is sufficient or thresholds for load handling by AI models and agents, etc.). A reward or penalty function may be used with an outcome of load balancing and AI agent selection and handling, which may consider multiple factors for resource usage, runtime, latency, accuracy, etc. The policy may then be updated by the RL mechanism and model such that the model is updated over time to better handle load balancing. As such, one or more ML or other AI algorithms and/or models may be used for AI agent selection.

In some embodiments, a dedupe module 135 and a product alert module 136 may also be utilized to provide additional features and processes for AI agent selection and/or support ticket handling of support tickets 138. For example, dedupe module 135 may utilize a BERT-based model to deduplicate the same or similar service requests from the same user and/or when requested for the same assistance. Product alert module 136 may utilize a BERT-based model to alert a product team of an issue with a computing service and/or product (both generally referred to herein as a “product”) where one or more users may be requesting assistance, such as if an error or issue in the product has been detected.

AI agents 137 may perform processing of support tickets 138 for insight extraction and determination of recommendations or other information that may be utilized by agents, such as an agent of agent device 140, when providing assistance to users for service requests. In some embodiments, AI agents 137 or another module and/or AI model may provide summarization for support tickets 138 for insights and recommendations. Summarization may be obtained through an LLM or other generative AI process that may utilize NNs, ML models, NLP capabilities, and the like trained and configured for data summarization abilities. Summarization may be performed by an ML module using GPT, Bidirectional Encoder Representations from Transformers (BERT), A Robustly Optimized BERT Pretraining Approach (ROBERTa), or other language model that may be utilized for data summarization. After content summarization, recommendations may be determined by AI agents 137 using an LLM or other AI model to extract information and utilize available product and/or assistance information to determine a recommended course of action for customer service and assistance. This may be based on user interactions, tasks, content, and product information. As such, AI agents 137 may interact with a live support 139 to provide support for live agents during real-time or asynchronous customer service and assistance communications.

In some embodiments, the AI models utilized by agent optimization pipeline 131 may include deep neural networks (DNNs), MLs, LLMs and other generative AIs, or other AI models trained using training data. For example, with LLMs, training data may correspond to different corpora of documents and information, which may then allow the models to respond intelligently based on learning for such corpora. The algorithm and architecture may correspond to BERT-based models and other DNNs, ML decision trees and/or clustering, LLMs and other generative AIs, and other types of AI, ML, and/or NN architectures. The training data may be used to determine features, such as through feature extraction and feature selection using the input training data. With DNN models and/or AI models using deep learning, the models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a deep learning algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input data and provide corresponding language outputs.

Layers, branches, clusters, or the like of the DNNs of may be trained by using training data associated with data records of interest, such as information associated with content, searching, and/or summarization tasks. In this regard, for training of models for AI agent selection and/or insight extraction tasks, corpora of documents associated with products and services (e.g., live products 123 of service applications 122, which may include computing services 124), customer assistance, and the like, as well as a more general knowledge base, may be used. By providing training data, the nodes in the hidden layer may be trained (adjusted) such that an optimal output (e.g., a classification) is produced in the output layer based on the training data. By continuously providing different sets of training data and/or penalizing the networks when the outputs are incorrect, models (and specifically, the representations of the nodes in the hidden layer) may be trained (adjusted) to improve their performance.

Service applications 122 may correspond to one or more processes to execute modules and associated specialized hardware of service provider system 120 to process a transaction and/or provide other computing services to users. For example, service applications 122 may be used to process payments and other services to one or more users, merchants, and/or other entities for transactions, where assistance in the use and/or integration of those services, applications, websites, data, and the like may be provided through customer service platform 130 in an automated and comprehensive manner. In this regard, users, including merchants and other entities, as well as customers and individual users, may establish a digital account for engagement with live products 123, such as the products and services of service provider system 120 that may be utilized by users and entities through computing services 124. For example, the account may be used to send and receive payments for a payment processing product of live products 123, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations. Other ones of live products 123 for financial services may be associated with account establishment, maintenance, and/or usage, transfers, risk and fraud, lending and/or underwriting, credit, and the like. However, other products and services may also be provided.

For example, service applications 122 may provide different computing services to users and entities through live products 123, including social networking, microblogging, media sharing, messaging, business and consumer platforms, etc. Use of, and/or integration of computing services 124 to use these products with an entities external and/or third-party platforms, applications, and systems, may require assistance, such as to answer a question or receive help regarding service usage or implementation in another application, or to receive instructions on use/implementation. As such, customer service platform 130 may be configured to assist users, such as a user utilizing client device 110, with customer service requests and support tickets 138 generated from such requests. In this regard, service applications 122 may be integrated with customer service platform 130 for customer service during the use of service applications 122.

Service applications 122 may provide additional features to service provider system 120. For example, service applications 122 may include security applications for implementing server-side security features, programmatic client applications for interfacing with appropriate APIs over network 150, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 150.

Additionally, service provider system 120 includes or may access database 126. Database 126 may store various identifiers associated with client device 110 and/or other devices and/or servers that may engage and/or interact with accounts and/or live products 123. Database 126 may also store account data, including payment instruments, financial information, account balances, and authentication credentials, as well as transaction processing histories and data for processed transactions. Although database 126 is shown as residing on service provider system 120 as a database, in other embodiments, other types of data storage and components may be used including cloud computing storage nodes, remote data stores and database systems, distributed database systems over network 150 and/or of a computing system associated with service provider system 120, and the like.

Service provider system 120 may include at least one network interface component 128 adapted to communicate client device 110, agent device 140, and/or other devices and servers over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Agent device 140 may be implemented as a communication device that may utilize appropriate hardware and software configured for wired and/or wireless communication with client device 110 and/or service provider system 120. For example, in one embodiment, agent device 140 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein. Agent device 140 of FIG. 1 includes and/or is associated with an application 142, an implementation of which is discussed further below

Application 142 may correspond to one or more processes to execute modules and associated devices of agent device 140 to provide a convenient interface to permit a user for agent device 140 (e.g., a live agent, although chatbots may converse with client device 110 in a similar manner to that discussed below) to provide customer service and other assistance through communications with AI agents 137 of service provider system 120 and client device 110. Where service provider system 120 may correspond to an online transaction processor, the services provided to agent device 140 may correspond to customer relationship management (CRM) services and systems, such as those that provide assistance via live, asynchronous, and/or automated chat service with agents and/or chatbots. However, in further embodiments, different customer service and assistance services may be provided via application 142, such as those associated with messaging, social networking, media posting or sharing, microblogging, data browsing and searching, online shopping, and other services available to users, customers, and the like of service provider system 120. Where application 142 may also or instead be executed by an automation chatbot, application 142 may correspond to a computing automation process or device that implements one or more chat workflows and skills for automated service assistance.

In this regard, when engaging in chats, conversations, and other dialogues for assistance to be provided to the user of client device 110, application 142 may be used to receive support ticket 144 having insights and other information for assistance provision provided from one of AI agents 137 selected for most optimal insight extraction and AI assistance by agent optimization pipeline 131. Support ticket 144 may be generated by service provider system 120 when the selected one of AI agents 137 processes the communications and other information from client device 110 for the service request, as discussed herein. Thereafter, support ticket 144 is output to the live agent of agent device 140 for use during customer service and assistance provision, such as in a user interface, window, pop-up, or the like with or in association with a chat, service request, communications, or the like. In various embodiments, application 142 may correspond to a general browser application configured to retrieve, present, and communicate information over the Internet (e.g., utilize resources on the World Wide Web) or a private network. For example, application 142 may provide a web browser, which may send and receive information over network 150, including retrieving website information, presenting the website information to the user, and/or communicating information to the website. However, in other embodiments, application 142 may include a dedicated software application of service provider system 120 or other entity (e.g., a merchant) resident on agent device 140 (e.g., a mobile application on a mobile device) that is displayable by a graphical user interface (GUI) associated with application 142.

Agent device 140 may include at least one network interface component 146 adapted to communicate client device 110, service provider system 120, and/or other devices and servers over network 150. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

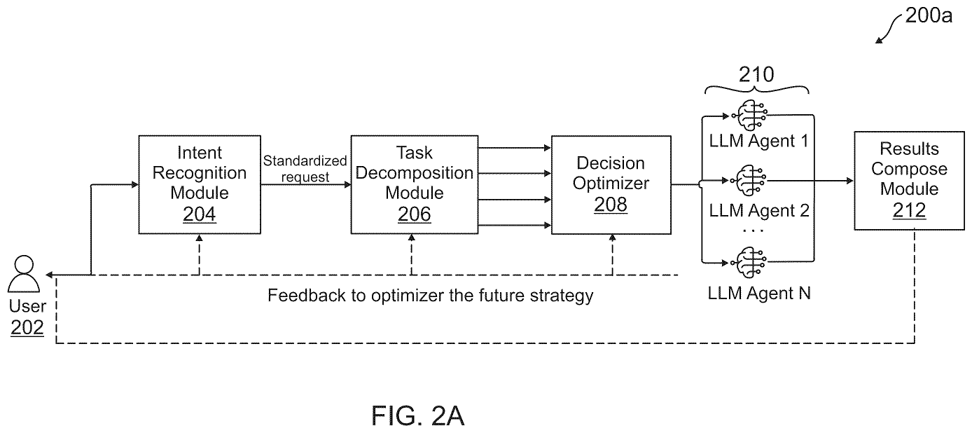

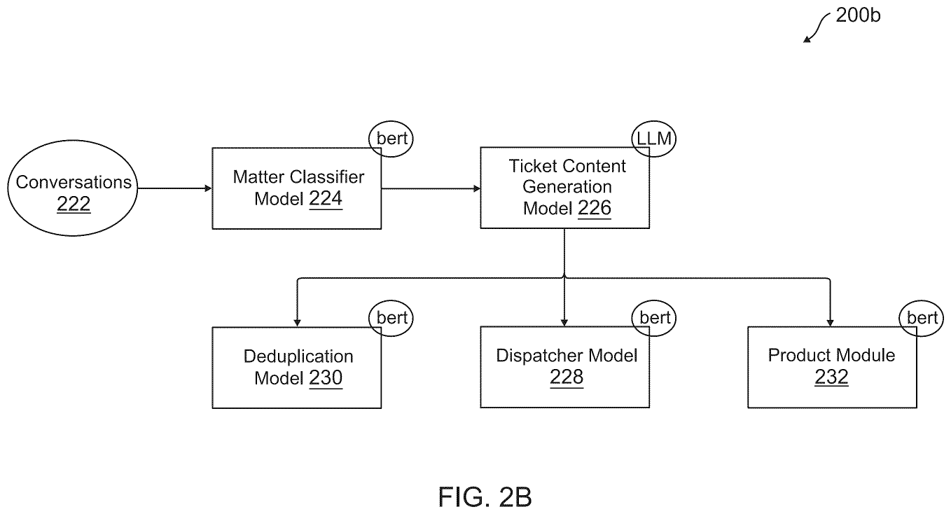

FIGS. 2A and 2B are exemplary system environments 200a and 200b for processing communications for service requests from users to optimally select an AI agent for insight extraction and recommendation, according to embodiments. System environments 200a and 200b include components of service provider system 120 that may be utilized by client device 110 to provide responses to user requests, such as customer service requests, using AI agents 137 selected using the processes and components of agent optimization pipeline 131, as discussed in reference to system 100 of FIG. 1. In this regard, system environments 200a and 200b may correspond to a computing system of service provider system 120 when providing customer service platform 130 for engagement with client device 110 and/or agent device 140.

In system environment 200a of FIG. 2A, an embodiment of customer service platform 130 is shown where a user 202 may interact with customer service platform 130 on service provider system 120 to request assistance. In this regard, user 202 may utilize client device 110, such as application 112, to access a webpage and/or web application; however, in other embodiments, customer service platform 130 may be accessed through different types of applications and UIs. User 202 may submit a request for assistance, such as through one or more communications, messages, or the like. As such, the request may be submitted in a conversational form and may include multiple communications, which have content and information associated with the request for customer service or assistance. Initially, an intent recognition module 204 may perform intent recognition, such as by classifying the request and/or communications for the request as being associated with a live product issue or other issue requiring assistance, such as an issue affecting a live product provided through or using a computing service of the service provider. This may include identifying what the communications are likely about, such as the live product and/or computing service associated with the communications.

Thereafter, a task decomposition module 206 may perform task decomposition and determination, such as one or more computing tasks for AI agent processing and/or execution, used to handle and/or respond to the communications and request. Task decomposition module 206 may include summarizing the communications, extracting data from the communications and/or summary, and/or generating a support ticket for request handling by the AI agents. The operations and models of intent recognition module 204 and task decomposition module 206 are discussed in further detail with regard to FIG. 2B below.

Decision optimizer 208 may perform load balancing and AI agent assignment using a load balancing mechanism and dispatcher model for AI agent selection and assignment for request and/or support ticket handling. In this regard, decision optimizer 208 may utilize the load balancing mechanism to analyze a current load of LLM agents 210 (or other AI agents), such as a number of tasks, requests, and/or support tickets assigned to each of LLM agents 210 and/or an expected resource usage of the assigned tasks, requests, and/or support tickets. The load balancing mechanism may continuously and/or periodically monitor the workload of each of LLM agents 210, where the workload may include the individual tasks and complexity of the tasks (e.g., computational resources used). As such, decision optimizer 208 may dynamically assign new tasks, such as new or incoming requests and/or support tickets, to an LLM of LLM agents 210 that has a least load and/or in a manner that may maintain and/or optimize overall system performance and efficiency.

Decision optimizer 208 may further analyze model performance during load balancing. For example, the load balancing mechanism may consider additional factors and data, such as model performance, when assigning new tasks to LLM agents 210. In this regard, model performance may include latency, accuracy, and/or NPS of the final output of the model and/or agent. This allows for a more balanced and comprehensive load balancing that considers model performance for more accurate agent responses and outputs. Decision optimizer 208 may further include a dispatcher component having one or more ML models, such as a deep learning model including a BERT-based language model or other BERT-based model, that may perform the AI agent selection and assignment based on the output of the load balancing mechanism.

In this regard, the dispatcher component may utilize reinforcement learning (RL) as a component in AI model and agent selection. RL may be used to update policies for AI agent selection over time, where, when a task is assigned, a policy may be chosen (randomly or based on a rule, progression, etc.) and used to determine an AI agent to handle a task based on the outputs of the load balancing mechanism. For example, a first policy may favor assigning the request or other task to an AI agent with a lowest overall workload, while a second policy may favor assigning to a combination of lowest workload with performance meeting or exceeding a threshold. Once the policy is chosen, the AI agent may be selected and the task assigned. Based on the outcome of task performance, such as the accuracy and/or speed of response generation to the request and communications, a reward or penalty may be applied to the policy and/or add or subtract from a weight applied to the policy and/or policy selection criteria for future AI agent selection and assignment.

In system environment 200b of FIG. 2B, the AI models of intent recognition module 204, task decomposition module 206, and decision optimizer 208 are shown in further detail, as well as models for deduplication of the same or similar requests and/or support tickets and product identification and/or notification for product issues. In this regard, conversations 222 may be received, such as from user 202, during the course of use of a customer service channel or platform, where the conversations may have dialogue (voice or text) and other conversational communications between the user and a live or automated agent. For processing of conversations 222, intent recognition module 204 may utilize a matter classifier model 224, such as a BERT-based language model or other deep learning model. Matter classifier model 224 may be trained on products and/or services of the service provider, computing services for those products and/or services, issues including live, past, and/or ongoing issues, and previous service requests. Matter classifier model 224 may therefore perform a filtering for what conversations 222 are likely about and their content, type, classification, or category.

Conversations 222 and their categorization may be provided to a ticket content generation model 226, which may correspond to a LLM or other generative AI with language capabilities and may be used by task decomposition module 206 for task determination from support ticket generation. In this regard, ticket content generation model 226 may perform content extraction and/or summarization, which may include converting or transforming conversations 222 to a support ticket based on support ticket formats or samples for support tickets that may be handled by AI agents and other real or automated agents. In this regard, the LLM of ticket content generation model 226 may be prompted with conversations 222 and an instruction to extract information for, summarize, and/or convert conversations 222 to a support ticket. When prompting the LLM of ticket content generation model 226, a sample or template of one or more support tickets may be provided, as well as the classification and other information. The output of the LLM may therefore correspond to a summarization and/or support ticket for task determination and assignment to an AI agent.

Thereafter, dispatcher model 228 used by decision optimizer 208 may be used to perform task assignment and support ticket handling and processing by AI agents. Dispatcher model 228 may therefore select an AI agent for handling of conversations 222 and/or the corresponding support ticket. Dispatcher model 228 may correspond to a BERT-based model or other deep learning model and may utilize the load balancing and RL for a policy gradient process to select AI agents and assign tasks. Deduplication model 230 and/or product model 232 may also be utilized to perform further operations. Deduplication model 230 and/or product model 232 may correspond to BERT-based models or other deep learning models and may perform operations associated with support ticket handling. For example, deduplication model 230 may search for recent support tickets and identify any same or similar tickets for deduplication. Product model 232 may identify a live or current issue with a live product being referenced by conversations 222 so that a product team may be alerted to identify the affected product and take action if resolution of errors or issues is required.

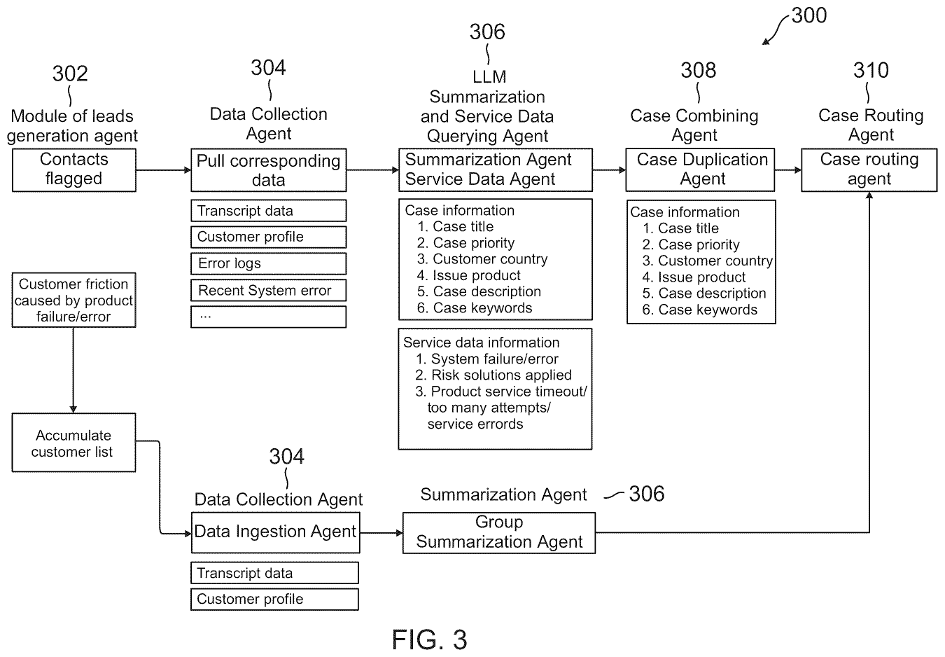

FIG. 3 is an exemplary diagram 300 of processes for data collection and summarization for routing of service requests and other cases to optimal AI agents for insight extraction and recommendation, according to various embodiments. Diagram 300 shows exemplary interactions between different AI and computing bots for AI agent assignment of requests for insight extraction and other handling. In this regard, the agents shown in diagram 300 may be provided by customer service platform 130 of service provider system 120 or other CRM system when processing incoming requests from users to assign those requests to AI models that may optimally process and generate inferences from the requests.

In diagram 300, a leads generation agent or issue detection agent 302 may perform issue detection through different interactions and/or communications. For example, issue detection agent 302 may interact with one or more customer service channels where communications from users may be reviewed and analyzed for determination of whether there is an issue affecting a live product being reported and identified by customers or other users. This may correspond to a product issue with the product, or an issue with the computing service, platform, application, or the like that provides the product to the users. As such, contacts may be flagged, such as those contacts with users by customer service agents. Issue detection agent 302 may also identify customer friction and/or impact encountered by customers due to product problems, errors, and/or failures. This customer friction may be identified from error logs and/or reports, and the reports, error logs, and the like may be used with communications reporting errors and failures to generate a customer impact list of customers impacted by the issue with the live product of the service provider.

A data collection agent 304 may be used to collect data associated with flagged contacts between customers and agents for support ticket generation and customer service request processing. In this regard, data collection agent 304 may pull corresponding data for the contacts and communications, such as transcript data from each contact, call, or other communication, customer profiles, error logs, recent system errors, and other information associated with the customer and/or live product issue being reported. An LLM summarization and service data querying agent 306 may receive the data collected and retrieved by data collection agent 304 and may include one or more AI agents, such as an LLM, BERT-based model, or other AI model, to process the collected data. LLM summarization and service data querying agent 306 may therefore use a summarization agent, such as a summarization LLM that may be trained to extract and summarize data from communications or other larger text data, to extract, determine, and/or summarize case information. The case information may include a case title, case priority, customer country, product and/or issue with the product, case description, case keywords, and other relevant information for support ticket generation and/or processing. LLM summarization and service data querying agent 306 may utilize a service data agent, such as an LLM or deep learning model, to determine service data for the service request and/or issue affecting the live product and/or computing service, such as a system failure or error, risk solutions that have been applied, product or service timeouts/too many requests/service error, or other relevant service information.

LLM summarization and service data querying agent 306 may generate a support ticket and/or provide the information for a support ticket to a case combining agent 308, which may perform deduplication and/or combining of customer service requests and support tickets that may be repeated or generated multiple times. In this regard, case combining agent 308 may include a case duplication agent that combines cases of duplicated product issues into a single support ticket, which may be based on the case information. LLM summarization and service data querying agent 306 and/or case combining agent 308 may also provide processes to verify that the issue is associated with and/or requests assistance with a live product of the service provider, such as a product provided via an online platform and/or from a production environment. After verification, deduplication and/or combining may be performed by case combining agent 308.

Case combining agent 308 may then provide the support ticket or other information for the request and processing by an AI agent to a case routing agent 310, which may send the case to the corresponding AI agent selected using the load balancing and selection optimization processes discussed herein. For issues detected from error logs and reports, where a customer impact list has been generated, data collection agent 304 may utilize a data ingestion agent to pull and/or retrieve transcript data and/or a customer profile for those communications and/or customers associated with the encountered errors and/or failures. LLM summarization and service data querying agent 306 may utilize a group summarization agent to summarize the transcripts for multiple customers to generate a group support ticket from the errors and/or failures. This summarization may be used for support ticket generation and forwarding to case routing agent 310 for assignment to an optimal AI agent for processing. In some embodiments, case routing agent 310 may further provide the support ticket and/or information to a product team, which may include a response, extracted insight, and/or recommendation from the AI agent. However, the AI agent may also route this information to a product team for live product management, maintenance, and/or review.

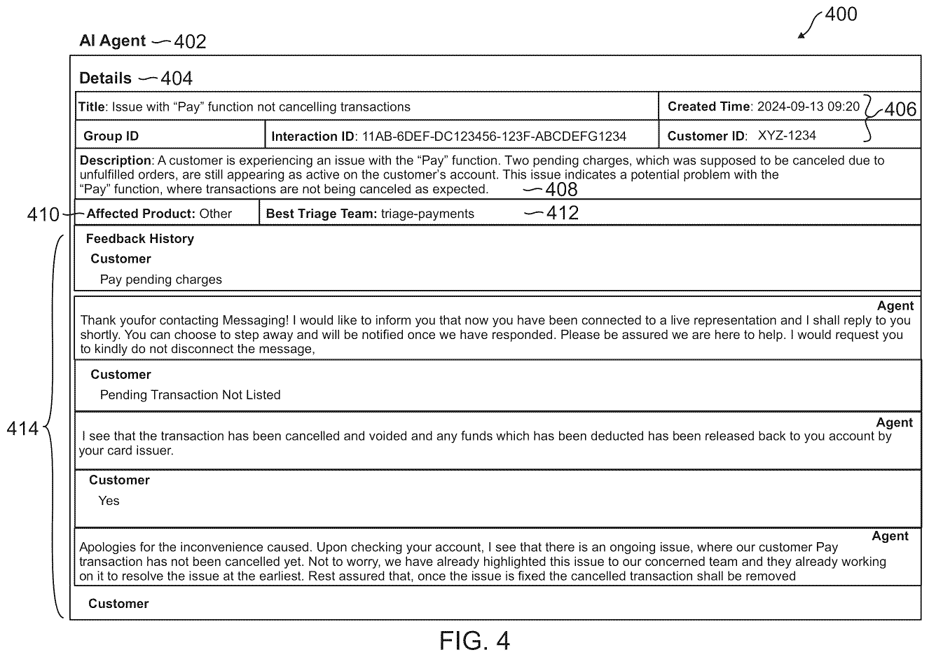

FIG. 4 is an exemplary user interface 400 displaying a support ticket for handling by an AI agent selected using an AI pipeline for optimized AI agent selection, according to various embodiments. User interface 400 includes information receivable, processable, and/or displayable by and/or on a computing device for processing a customer service request based on a support ticket generated by customer service platform 130. As such, user interface 400 may be displayed via application 142 on agent device 140 in system 100 of FIG. 1, based on engagement with customer service platform 130 of service provider system 120 to handle service request 114 from client device 110. An AI agent 402 may assist in processing support ticket details 404, such as by providing insight extraction and/or product, topic, or information recommendation for responding to service request 114.

For example, an agent viewing user interface 400 may be interested in learning more about a topic associated with the request for service summarized in support ticket details 404. AI agent 402 may assist with determining that topic and/or information for the topic, such as an issue facing a product, troubleshooting and assistance with the product and/or product's issue(s), and the like. AI agent 402 may correspond to an LLM or other AI model that may therefore provide communication insights and topic or other information recommendation to the agent. AI agent 402 may process the support ticket having the information shown in support ticket details 404.

For example, support ticket details 404 may include ticket identifiers 406, such as a title, timestamp, group ID, interaction ID, and/or customer ID, which may be used to track the communications and support ticket, as well as provide deduplication when multiple tickets may be generated for the same or similar (e.g., overlapping) communications and service requests. A description 408 may be generated using an LLM or other generative AI, which may summarize the communications in sufficient conciseness for agent review and handling. Description 408 may be generated using keyword extraction and natural language capabilities of an LLM or other generative AI, and may provide information that may be processable by another LLM or other deep learning model when determining a product recommendation.

AI agent 402 may provide a recommendation for handling of the support ticket and service request based on support ticket details 404 and affected product 410, which may be generated for a triage team 412. For example, AI agent 402 may determine, based on affected product 410, an assistance topic or the like to assist triage team 412 with handling the request and support ticket. Further AI agent 402 may base this recommendation on communications 414, such as a feedback history of requests, messages, and other communications by the user to the customer service channel, platform, or the like. The recommendation may be based on and/or provided with insights extracted from communications 414, such as an issue that the user is facing, an urgency or escalation required, and the like. As such, AI agent 402 may provide actionable information for handling of the service request in the most efficient, accurate, and optimal manner.

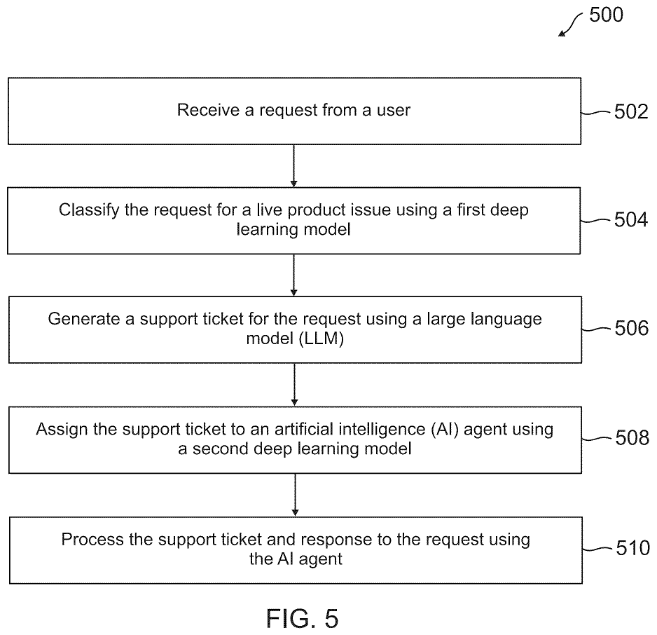

FIG. 5 is a flowchart 500 of an exemplary process for communication insights from optimal AI model selection during computing service issue handling, according to an embodiment. Note that one or more steps, processes, and methods described herein of flowchart 500 may be omitted, performed in a different sequence, or combined as desired or appropriate.

At step 502 of flowchart 500, a request from a user is received. For example, customer service platform 130 of service provider system 120 may receive service request 114 from client device 110. Service request 114 may correspond to a question, query, statement, or the like having a request (direct or indirect) for information, assistance, or service for a product of live products 123 offered by service provider system 120, such as through computing services 124. For example, service request 114 may request assistance with one or more of the account, payment processing, financial services, communication, or other products or services provided by service provider system 120 when acting as a transaction processor and/or payment provider platform. As such, the request may require assistance from a product team and/or live or automated agent, where an AI agent may be used initially to extract insights and provide recommendations for downstream processing and response to the request. The request may be any type of communication by the user with an automated agent or chatbot, as well as a live agent utilizing an application or program to interface with the automated agent or chatbot. As such, different types of communications may be received that may not necessarily correspond to a direct request from a user, such as an email communication or outreach for information or to report a problem, and a request for assistance or support may be determined from the communication(s) by the user. As such, any communication with an endpoint of a service provider may be received and analyzed for AI agent classification and assignment, as discussed herein.

At step 504, the request for a live product issue is classified using a first deep learning model. The first deep learning model may correspond to a BERT-based model; however, other deep learning models, NNs, and/or ML models may also be used including language models. The deep learning model may be trained based on previous service requests and handling including responses to the service requests and/or teams, agents, chatbots, communication channels, and the like used to handle the requests. Further, the deep learning model may be trained on and/or have knowledge of the service provider's products and computing services such that classification may be performed. Classification of the request may identify, flag, and/or tag the service request with an identification of a particular category, product, and/or live product issue that assistance or service is being requested for by the request. As such, classification may allow for identification and grouping of the request with other same and/or similar requests, as well as assignment of the request to particular AI agents and product teams for handling.

At step 506, a support ticket for the request is generated using an LLM. An LLM or other generative AI that may provide language capabilities for data extraction and/or summarization tasks may be used to generate a support ticket in a support ticket format, layout, and/or data content from the initial request and/or communications. For example, the request may correspond to communications in a communication channel, such as emails (or other asynchronous communications), chat text, and/or the like. Based on such communications, the service provider's AI agents may require a support ticket for insight extraction and recommendation. As such, an LLM may perform extraction and summarization of the relevant portions for support ticket generation and may create a support ticket. The LLM may be prompted with the communications and an instruction to generate a support ticket and may also receive examples of support tickets or other input utilized by an AI agent for processing. Support tickets can take on any suitable format based on the next or subsequent users of the support ticket, such as a ML model, a human user, a chat assistant, an AI agent, or other computing system. As such, support tickets generally refer to data that represents information associated with an identified service request.

At step 508, the support ticket is assigned to an AI agent using a second deep learning model. A second deep learning model may be trained to perform selective AI agent assignment of support tickets and/or other data for requests, which may be based on a load balancing mechanism that considers capabilities of the AI agents with their current load and/or predicted load and throughput, where the capabilities may include training, product knowledge or expertise, accuracy, past performance, and the like. For example, the load balancing mechanism of the deep learning model may consider the current workload, as well as the computational resources required to complete the tasks of that workload, thereby ensuring that no single AI agent is overwhelmed, and system efficiency is improved.

Further, the load balancing mechanism may consider model performance, such as accuracy and/or NPS of the final output during selection by the second deep learning model. The second deep learning model may include a decision optimizer that utilizes a policy gradient process implementing RL for policy updating based on rewards and penalties from AI agent assignment. For example, when the support ticket for the request is received and processed by the second deep learning model, a policy for AI agent assignment may be utilized to determine an AI agent to handle the support ticket for insight extraction and/or response or assistance recommendation. Thereafter, a reward function may consider the output of the AI agent for use by the downstream agent, team, or system responding to the request, which may include consideration of the actual cost of resources utilized to obtain the result, the runtime/latency of obtaining the output, and/or the accuracy of task completion by the AI agent. The policy may then be updated using RL of the policy gradient process, which may allow for feedback to adjust the policy over time. Further, the decision optimizer may perform real-time decisions of AI agent assignment using ML processes, which may consider AI agent capabilities to handle input data and/or provide outputs. For example, with LLMs, the decision optimizer may consider the input token size, input task type, other input information, and the current system status (e.g., usage, pressure, latency for each model, etc.). The decision optimizer may use a loss function to measure the difference between the predicted and actual outcomes, which may be represented by a function that takes in a state and an action and outputs the next state and a reward for completion of the previous action.

At step 510, the support ticket and response to the request is processed using the AI agent. The AI agent may perform insight extraction and assistance recommendation for output to a downstream live or automated agent processing and/or directly to the user for a response to the user's request. In this regard, the AI agent may utilize an LLM or other language model to parse the support ticket and/or other content of the user's request and identify a thematic structure, user interest, and/or keywords for response generation. As such, content that aligns with the extracted data may be identified and recommended for the request. The content may correspond to assistance topics, product information, or the like that may assist the user and/or an agent helping the user with the request. As such, a more accurate and efficient output may be provided to the user based on the selective assignment of the request and support ticket to an AI agent with the best capabilities and availability for handling of the request.

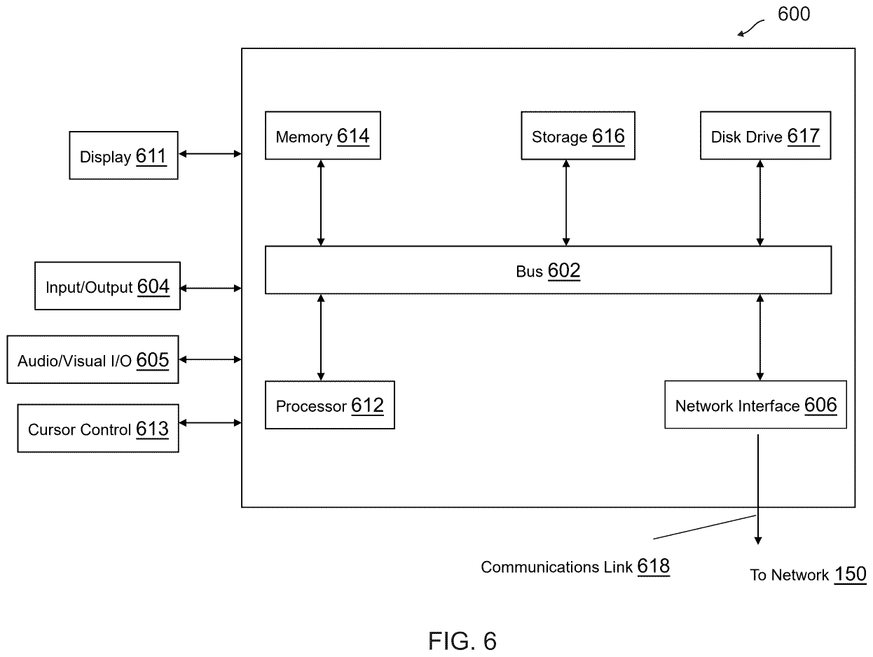

FIG. 6 is a block diagram of a computer system 600 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals and/or use video to capture still or video images and provide video input. Audio I/O component 605 may allow the user to hear audio and/or view video. A transceiver or network interface 606 transmits and receives signals between computer system 600 and other devices, such as another communication device, service device, or a service provider server via network 150. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A method comprising:
receiving a request from a user for assistance with an issue;
classifying, using a first deep learning model and based on content in the request, the issue as a live product issue associated with a computing service provided by a service provider;
generating, using a large language model (LLM) and based on the content in the request, a support ticket for the request, wherein the support ticket identifies the issue in a format processable by a second deep learning model;
processing, using the second deep learning model, the support ticket for an identification of a first artificial intelligence (AI) agent of a plurality of AI agents; wherein the processing comprises:
determining, based on monitored activities of the plurality of AI agents, a workload of each of the plurality of AI agents;
determining a model performance metric of each of the plurality of AI agents that corresponds to the workload, and
identifying the first AI agent from the plurality of AI agents based on the workload, the model performance metric, and a policy gradient process, wherein the policy gradient process weights assignment policies for computing tasks to the plurality of AI agents based on feedback from completion of the computing tasks, and wherein the policy gradient process applies a reward or a penalty to the assignment policies based on an outcome of the response to the user and updates the assignment policies based on the reward or the penalty;
executing a call to the first AI agent to handle the request for assistance with the issue on behalf of the user based on the identification and the support ticket;
receiving a response to the call from the first AI agent; and
outputting the response to the user.

2. The method of claim 1, wherein, prior to the generating the support ticket, the method further comprises:
verifying, by the LLM, that the request involves the live product issue based on a knowledge base of computing services that provides live products of the service provider to computing devices.

3. The method of claim 2, further comprising:
summarizing, after the verifying, the content in the request using the LLM.

4. The method of claim 1, wherein the classifying comprises:
identifying, using the LLM, that the content in the request indicates that the issue is being encountered by the user when utilizing the computing service; and
determining, using the LLM, the live product issue associated with the computing service based on a live product provided through the computing service.

5. The method of claim 1, wherein the first deep learning model is trained based on conversations related to at least the live product issue and the second deep learning model is trained based on capabilities of the plurality of AI agents and live products of the service provider.

6. The method of claim 1, further comprising:
searching for other support tickets using a third deep learning model; and
providing the other support tickets to the first AI agent for handling of the request from the user with the support ticket.

7. The method of claim 1, further comprising:
predicting an affected product of the service provider based on at least one of the support ticket, the computing service, or the live product issue using a third deep learning model; and
outputting an indication of the predicted affected product to a product support system.

8. The method of claim 1, wherein the generating the support ticket using the LLM is further based on account information for an account of the user and one or more computing logs associated with past computing actions performed and past computing errors encountered by a computing device of the user is associated with the issue.

9. (canceled)

10. A system comprising:
a non-transitory memory; and
one or more hardware processors coupled to the non-transitory memory and configured to execute instructions to cause the system to:
receive a request from a user;
predict an intent of the request using a large language model (LLM) and the request, wherein the intent is for assistance with an issue for the user;
identify one or more computing tasks that are executable for handling the request using the LLM;
determine one of a plurality of artificial intelligence (AI) agents capable of performing the one or more computing tasks to handle the request based on a load balancing mechanism, wherein the load balancing mechanism:
determines, based on monitored activities of the plurality of AI agents, a workload of each of the plurality of AI agents;
determines a model performance metric of each of the plurality of AI agents that corresponds to the workload; and
identifies the one of the plurality of AI agents based on the workload, the model performance metric, and a policy gradient process, wherein the policy gradient process weights assignment policies for computing tasks to the plurality of AI agents based on feedback from completion of the computing tasks, and wherein the policy gradient process applies a reward or a penalty to the assignment policies based on an outcome of the response to the user and updates the assignment policies based on the reward or the penalty;
route the request to the one of the plurality of AI agents;
generate a response to the request using the one or of the plurality of AI agents and the one or more computing tasks; and
output the response to the user.

11. The system of claim 10, wherein determining the one of the plurality of AI agents comprises analyzing, using the load balancing mechanism, the workload of each of the plurality of AI agents based on incoming requests processed by the plurality of AI agents.

12. The system of claim 11, wherein determining the one of the plurality of AI agents comprises determining, using the load balancing mechanism, a model performance of each of the plurality of AI agents based at least on the model performance metric.

13. The system of claim 12, wherein the processing load comprises a number of tasks being processed by each of the plurality of AI agents and one or more resources required by each of the tasks, and wherein the model performance comprises at least one of a latency, an accuracy, or a net promoter score (NPS) of each of the plurality of AI agents.

14. The system of claim 10, wherein, prior to receiving the support ticket, executing the instructions further causes the system to:
generate the support ticket using another LLM configured for at least one of information extraction or information summarization.

15. The system of claim 14, wherein, prior to generating the support ticket, executing the instructions further causes the system to:
classify the request using a deep learning model.

16. The system of claim 14, wherein prior to generating the support ticket, executing the instructions further causes the system to:
summarize information from one or more communications associated with the request using the other LLM; and
verify that the summarized information is related to a product associated with the issue.

17. The system of claim 10, wherein the load balancing mechanism is provided by a language-based deep learning model.

18. The system of claim 10, wherein executing the instructions further causes the system to:
determine a recommendation for one of an action or a topic for responding to the request from the user using the one of the plurality of AI agents and based on the support ticket,
and wherein the response is further generated based on the recommendation and one of input from a live agent or an output of an automated chatbot.

19. A non-transitory machine-readable medium having stored thereon machine-readable instructions executable to cause a machine to perform operations comprising:
receiving a request from a user;
classifying, using a first deep learning model, the request as associated with a product of a service provider;
generating, using a large language model (LLM), a summarization of the request for
processing by an artificial intelligence (AI) agent of a plurality of AI agents;
assigning the summarization to the AI agent from the plurality of AI agents based on a processing load and a performance of each of the plurality of AI agents, wherein the assigning comprises:
determining, based on monitored activities of the plurality of AI agents, a workload of each of the plurality of AI agents;
determining a model performance metric of each of the plurality of AI agents that corresponds to the workload; and
identifying the AI agent from the plurality of AI agents based on the workload, the model performance metric, and a policy gradient process, wherein the policy gradient process weights assignment policies for computing tasks to the plurality of AI agents based on feedback from completion of the computing tasks, and wherein the policy gradient process applies a reward or a penalty to the assignment policies based on an outcome of the response to the user and updates the assignment policies based on the reward or the penalty; and
processing the summarization using the AI agent, wherein the processing includes providing a response to the user based on an output of the AI agent.

20. The non-transitory machine-readable medium of claim 19, wherein the plurality of AI agents comprises two or more LLMs, and wherein the processing the summarization comprises:
extracting, using one of the two or more LLMs corresponding to the AI agent, information associated with an issue encountered by the user with the product;
determining a topic associated with assistance for the issue and the product based on the extracted information; and
outputting the topic to one of the user or an additional agent handling the request with the user.
